(19) United States
(12) Patent Application Publication
(10) Pub. No.: US 2015/0006479 A1
(43) Pub. Date: Jan. 1, 2015

(54) Systems And Methods For Data Management

(71) Applicant: thePlatform for Media, Inc., Seattle, WA (US)

(72) Inventors: Chun Hsu, Issaquah, WA (US); Michael Horwitz, Seattle, WA (US); Brian Stephens, Seattle, WA (US)

(21) Appl. No.: 13/932,557

(22) Filed: Jul. 1, 2013

(51) Int. Cl. G06F 17/30

(52) U.S. Cl. CPC G06F 17/30575
USPC 707/610

(57) ABSTRACT

Systems and methods for managing data are disclosed. One method can comprise migrating first data from a first database to a second database by storing the first data as second data in the second database, modifying at least a portion of the first data during migration of the first data, providing a notification to the second database based on the modification of the first data, and modifying the second data based upon the notification, wherein the second data is modified to match at least a portion of the modified first data.

### BACKGROUND

During migration of data, a portion of the data being migrated is often unavailable to a user. In certain circumstances, source data can be made available to a user during migration. However, changes to the source data may not be reflected in the migrated data. Complete migration of large data sets can be time intensive and can limit user access to data for substantial periods of time. Further, many database replication schemes can only replicate the entire data set and do not have the ability to migrate data subsets, for example data for individual customers. Therefore, if a database contains data for multiple customers, it may not be possible to migrate only data for one customer to another database. These and other shortcomings are identified and addressed by the disclosure.

### SUMMARY

It is to be understood that both the following general description and the following detailed description are exemplary and explanatory only and are not restrictive, as claimed. Provided are methods and systems for data management. The methods and systems described herein, in one aspect, provide a notification of modification of data. As an example, a computing device can receive such notification and automatically update data in response to the notification.

In an aspect, a method can comprise storing first data in a first database. The first data can be migrated from the first database to a second database by storing the first data as second data in the second database. A request for modification of the first data in the first database can be received during migration of the first data. A notification based on the request for modification can be generated. The second data can be modified based on the notification.

In another aspect, a method can comprise migrating first data from a first database to a second database by storing the first data as second data in the second database. At least a portion of the first data can be modified during migration of the first data. A notification can be provided to the second database based on the modification of the first data. The second data can be modified based upon the notification, wherein the second data is modified to match at least a portion of the modified first data.

In yet another aspect, a method can comprise monitoring a first database. A notification can be received relating to a modification of data stored in the first database. Transmission of modified data to a second database can be automatically requested based on the notification.

In a further aspect, a system can comprise a first database comprising first data, a second database comprising second data, and a computing device in communication with the first database and the second database. The computing device can be configured to receive a request for modification of the first data. The first data can be modified based upon the request for modification. A notification can be provided to the second database based on the request for modification. The second data can be modified based upon the notification, wherein the second data is modified to match at least a portion of the first data.

Additional advantages will be set forth in part in the description which follows or may be learned by practice. The advantages will be realized and attained by means of the elements and combinations particularly pointed out in the disclosure. It is to be understood that both the foregoing general description and the following detailed description are exemplary and explanatory only and are not restrictive, as claimed.

### BRIEF DESCRIPTION OF THE DRAWINGS

The accompanying drawings, which are incorporated in and constitute a part of this specification, illustrate embodiments and together with the description, serve to explain the principles of the methods and systems:

FIG. 1A is a block diagram of an exemplary system and network;

FIG. 1B is a block diagram of an exemplary system and network;

FIG. 2 is a block diagram of an exemplary computing system;

FIG. 3 is a flow chart of an exemplary method;

FIG. 4 is a flow chart of an exemplary method; and

FIG. 5 is a flow chart of an exemplary method.

### DETAILED DESCRIPTION

Before the present methods and systems are disclosed and described, it is to be understood that the methods and systems are not limited to specific methods, specific components, or to particular implementations. It is also to be understood that the terminology used herein is for the purpose of describing particular embodiments only and is not intended to be limiting.

As used in the specification and the appended claims, the singular forms “a,” “an” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by use of the antecedent “about,” it will be understood that the particular value forms another embodiment. It will be further understood that the endpoints of each of the ranges are significant both in relation to the other endpoint, and independently of the other endpoint.

“Optional” or “optionally” means that the subsequently described event or circumstance may or may not occur, and that the description includes instances where said event or circumstance occurs and instances where it does not.

Throughout the description and claims of this specification, the word “comprise” and variations of the word, such as “comprising” and “comprises,” means “including but not limited to,” and is not intended to exclude, for example, other components, integers or steps. “Exemplary” means “an example of” and is not intended to convey an indication of a preferred or ideal embodiment. “Such as” is not used in a restrictive sense, but for explanatory purposes.

Disclosed are components that can be used to perform the disclosed methods and systems. These and other components are disclosed herein, and it is understood that when combinations, subsets, interactions, groups, etc. of these components are disclosed that while specific reference of each various individual and collective combinations and permutation of these may not be explicitly disclosed, each is specifically contemplated and described herein, for all methods and systems. This applies to all aspects of this application including, but not limited to, steps in disclosed methods. Thus, if there are a variety of additional steps that can be performed it is understood that each of these additional steps can be performed with any specific embodiment or combination of embodiments of the disclosed methods.

The present methods and systems may be understood more readily by reference to the following detailed description of preferred embodiments and the examples included therein and to the Figures and their previous and following description.

As will be appreciated by one skilled in the art, the methods and systems may take the form of an entirely hardware embodiment, an entirely software embodiment, or an embodiment combining software and hardware aspects. Furthermore, the methods and systems may take the form of a computer program product on a computer-readable storage medium having computer-readable program instructions (e.g., computer software) embodied in the storage medium. More particularly, the present methods and systems may take the form of web-implemented computer software. Any suitable computer-readable storage medium may be utilized including hard disks, CD-ROMs, optical storage devices, or magnetic storage devices.

Embodiments of the methods and systems are described below with reference to block diagrams and flowchart illustrations of methods, systems, apparatuses and computer program products. It will be understood that each block of the block diagrams and flowchart illustrations, and combinations of blocks in the block diagrams and flowchart illustrations, respectively, can be implemented by computer program instructions. These computer program instructions may be loaded onto a general purpose computer, special purpose computer, or other programmable data processing apparatus to produce a machine, such that the instructions which execute on the computer or other programmable data processing apparatus create a means for implementing the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide steps for implementing the functions specified in the flowchart block or blocks.

Accordingly, blocks of the block diagrams and flowchart illustrations support combinations of means for performing the specified functions, combinations of steps for performing the specified functions and program instruction means for performing the specified functions. It will also be understood that each block of the block diagrams and flowchart illustrations, and combinations of blocks in the block diagrams and flowchart illustrations, can be implemented by special purpose hardware-based computer systems that perform the specified functions or steps, or combinations of special purpose hardware and computer instructions.

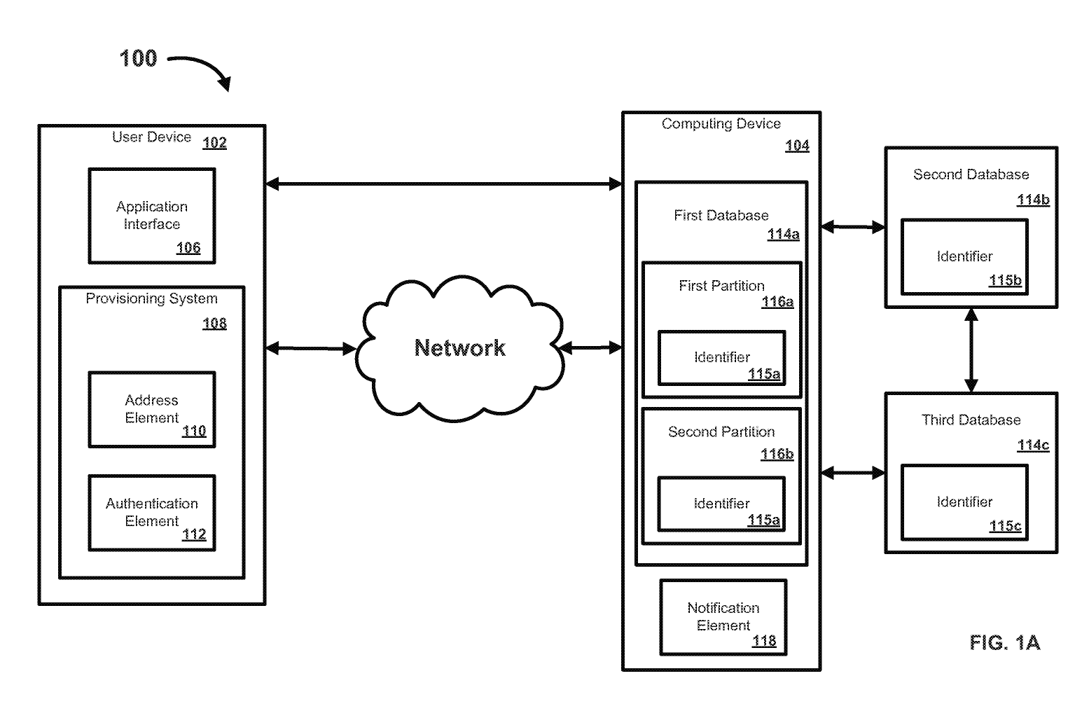

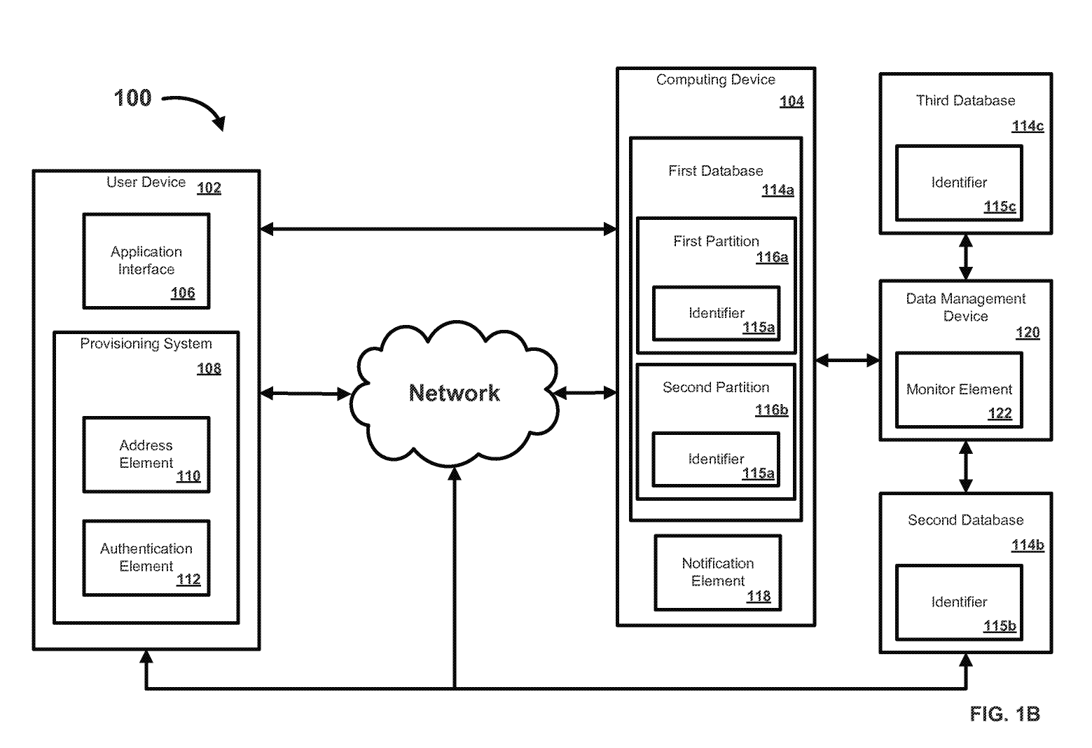

In an aspect, various aspects of an exemplary system and network can provide a notification of modification of data. As an example, a computing device can receive such notification and automatically update data in response to the notification. As an example, FIGS. 1A-1B illustrate various aspects of an exemplary system and network in which the present methods and systems can operate. The present disclosure relates to systems and methods for managing data. Those skilled in the art will appreciate that present methods may be used in systems that employ both digital and analog equipment. One skilled in the art will appreciate that provided herein is a functional description and that the respective functions can be performed by software, hardware, or a combination of software and hardware.

The system and network 100 can comprise a user device 102 in communication with a computing device 104 such as a server, for example. The computing device 104 can be disposed locally or remotely relative to the user device 102. As an example, the user device 102 and the computing device 104 can be in communication via a private or public network such as the Internet. Other forms of communication can be used, such as wired and wireless telecommunication channels, for example.

In an aspect, the user device 102 can be an electronic device, such as a computer, a smartphone, a laptop, a tablet, a set top box, or other device capable of communicating with the computing device 104. As an example, the user device 102 can comprise an application interface 106 for providing an interface to a user to interact with the user device 102 and/or the computing device 104. The application interface 106 can be any interface for presenting information to the user and receiving a user feedback such as a web interface (e.g., Internet Explorer, Mozilla Firefox, Google Chrome, Safari, or the like). Other software, hardware, and/or interfaces can be used to provide communication between the user and one or more of the user device 102 and the computing device 104. As an example, the application interface 106 can request or query various files from a local source and/or a remote source.

In an aspect, the user device 102 can comprise a provisioning system 108 configured, among other things, to: authenticate the user device 102 with a particular network; install drivers; configure a modem; set up a wired or wireless Local Area Network (LAN); secure an operating system; configure browser provider-specifics; provision electronic mail (e.g. create mailboxes and aliases); configure electronic communications; install additional support software; install add-on packages; and the like. As an example, the provisioning system 108 can be configured to provision and/or monitor one or more address elements 110 and an authentication element 112 to the user device 102.

In an aspect, the address element 110 can be a uniform resource identifier (URI) (e.g., a uniform resource locator (URL)), a network address, an Internet address, or the like. As an example, the address element 110 can be relied upon to establish a communication session between the user device 102 and the computing device 104. As a further example, the address element 110 can be any identifier to distinguish the user device 102 from other devices intercommunicating with the computing device.

In an aspect, the authentication element 112 can be credentials, a token, a character, a string, or the like, for differentiating one user or user device from another user or user device. In an aspect, the authentication element 112 can comprise information for authenticating the user and/or user device 102 with the computing device 104 to facilitate access to data and/or services. As an example, the computing device 104 can be configured to receive and validate the authentication element 112 to facilitate a secure communication between the user device 102 and one or more of the computing devices such as computing device 104.

In an aspect, the computing device 104 can be a server for communicating with the user device 102. As an example, the computing device 104 can manage and/or monitor the intercommunication between the user device 102 and one or more databases 114a, 114b, 114c for sending and receiving data therebetween. In an aspect, the databases 114a, 114b, 114c can store a plurality of information sets (e.g. data sets, files, web pages, etc.). As an example, the user device 102 can request an information set from the databases 114a, 114b, 114c. As a further example, the user device 102 can retrieve one or more information sets from the databases 114a 114b, 114c. In another aspect, one or more identifiers 115a, 115b, 115c can be associated with one or more of the information sets stored on and/or retrievable by the computing device 104. As an example, one or more identifiers 115a, 115b, 115c can comprise a uniform resource identifier (URI) (e.g., a uniform resource locator (URL)), a network address, an Internet address, a file name, a character string, token, or the like. As a further example, the one or more identifiers 115a, 115b, 115c can direct the application interface 106 to request or query a particular information set. The requested information set can be stored locally to the computing device 104 or remotely, such as in databases 114a, 114b, 114c for example. As an example, one or more of the databases 114a, 114b, 114c can be integrated with the computing device 104. As a further example, one or more databases 114a, 114b, 114c can be disposed remotely from the computing device 104.

In an aspect, one or more of the databases 114a, 114b, 114c, such as a first database 114a, can comprise one or more partitions 116a, 116b. As an example, the one or more of the partitions 116a, 116b can comprise a division of first database 114a or its constituting elements into distinct independent parts or data. Such partitioning can facilitate improved manageability, performance or resource availability. In an aspect, a computing device, such as computing device 104, can perform load balancing over one or more of the databases 114a, 114b, 114c and/or partitions 116a, 116b. As an example, load balancing can comprise distributing storage and/or workload across multiple databases partitions, computers or a computer cluster, network links, central processing units, disk drives, or other resources, to achieve optimal resource utilization, maximize throughput, minimize response time, and avoid overload. Using multiple components with load balancing, instead of a single component, can increase reliability through redundancy. As a further example, load balancing can be facilitated by migrating (e.g., replicating, copying, moving, dividing, etc.) data between multiple locations. In an aspect, data can be migrated from the first database 114a to one or more of a second database 114b and a third database 114c. In another aspect, data can be migrated from a first partition 116a to a second partition 116b. In yet another aspect, data migration can comprise transferring (e.g., replicating, copying, moving, dividing, etc.) data between storage types, formats, or computer systems. As an example, data migration can be performed programmatically to achieve an automated migration.

In an aspect, the computing device 104 can comprise a notification element 118. As an example, the notification element 118 can be disposed locally or remotely relative to the computing device 104. In another aspect, the notification element 118 can be configured to provide (e.g., generate, retrieve, transmit, store, make available, etc.) a notification. As a further example, the notification can comprise information relating to one or more of the computing device 104 and the databases 114a, 114b, 114c. The notification can relate to other devices and can comprise various forms of information. In another aspect, the notification element 118 can monitor one or more of the computing device 104 and the databases 114a, 114b, 114c. As such, the notification element 118 can provide a notification based upon an event, such as a change with one or more of the computing device 104 and the databases 114a, 114b, 114c. As an example, the notification can be provided based upon a modification of data stored on one or more of the one or more of the databases 114a, 114b, 114c. Notifications can be provided based on other triggers such as re-indexing of data, modification the database schema, and the like. In an aspect, notifications can be or comprise HTTP response bodies, such as:

```
{
    “$xmlns”: {
      “plcategory”: “xml.example.com/Category”
    },
    “id”: 41443634,
    “method”: “post”,
    “type”: “Category”,
    “entry”: {
      “id”: “example.com/data/1234”,
      “updated”: 1360267140000,
      “ownerId”:“example.com/data/Account/2429506505”,
      “updatedByUserId”:
“identity.auth.test.corp.example.com/idm/data/User/mps/249914844”,
      “plcategory$fullTitle”: “msn”,
      “plcategory$scheme”: “catalog.example.com”
}
```

As an example, a notification can comprise an identifier, such as a numeric identifier, for the notification. The identifier can allow users to stop or pause processing and resume at a later time without losing data. As another example, a notification can comprise one or more operations performed (e.g., create, delete, or update). As another example, a notification can comprise a type of object that was modified (e.g., Media or Category). As a further example, a notification can comprise one or more attributes of the object, such as a unique identifier of the object, a title, and a time and/or date the object was modified. Other information can be included as part of the notification.

As illustrated in FIG. 1B, the system and network 100 can comprise a data management device 120. In an aspect, the data management device 120 can comprise a media data service configured to generate, communicate, and/or persist information about content and the servers that store and deliver the content. As an example, the user device 102 makes direct calls to the media data service to create, retrieve, update, and delete the data objects used to model content metadata and server information. As a further example, the media data service also stores account-level settings for media management policies such as content retention and default metadata values.

In an aspect, the data management device 120 can comprise a file management service (FMS) configured to coordinate file processing operations, such as copying, moving, and encoding digital assets. As an example, the FMS can be configured to manage a storage and delivery location of one or more data sets, such as video assets.

In an aspect, the data management device 120 can comprise a Video Management System (VMS). As an example, the VMS can be configured as a set of Web services for media management, such as storing metadata about content assets and managing the assets. As an example, client applications, such as application interface 106, can integrate directly with the data management device 120 to integrate data, such as a video metadata, with an external content management system (CMS).

As illustrated in FIG. 1B, the system and network 100 can comprise a monitoring element 122. In an aspect, the monitoring element 122 can be configured to monitor (e.g., track, query, ping, etc.) one or more of the databases 114a, 114b, 114c. In another aspect, information relating to the one or more databases 114a, 114b, 114c can be monitored and analyzed by other elements. As such, changes to the one or more databases 114a, 114b, 114c can be detected by an element such as the monitoring element 122. As an example, the monitoring element 122 can be configured to receive notifications, such as from the notification element 120.

In an aspect, a computing device such as computing device 104 can perform load balancing over one or more of the databases 114a, 114b, 114c and/or partitions 116a, 116b. As an example, load balancing can comprise distributing storage and/or workload across multiple databases, partitions, computers or a computer cluster, network links, central processing units, disk drives, or other resources, to achieve optimal resource utilization, maximize throughput, minimize response time, and avoid overload. Using multiple components with load balancing, instead of a single component, can increase reliability through redundancy. As a further example, load balancing can be facilitated by migrating (e.g., replicating, copying, moving, dividing, etc.) data between multiple locations. In an aspect, data can be migrated from the first database 114a to one or more of a second database 114b and a third database 114c. In another aspect, data can be migrated from a first partition 116a to a second partition 116b. In yet another aspect, data migration can comprise transferring (e.g., replicating, copying, moving, dividing, etc.) data between storage types, formats, or computer systems. As an example, data migration can be performed programmatically to achieve an automated migration.

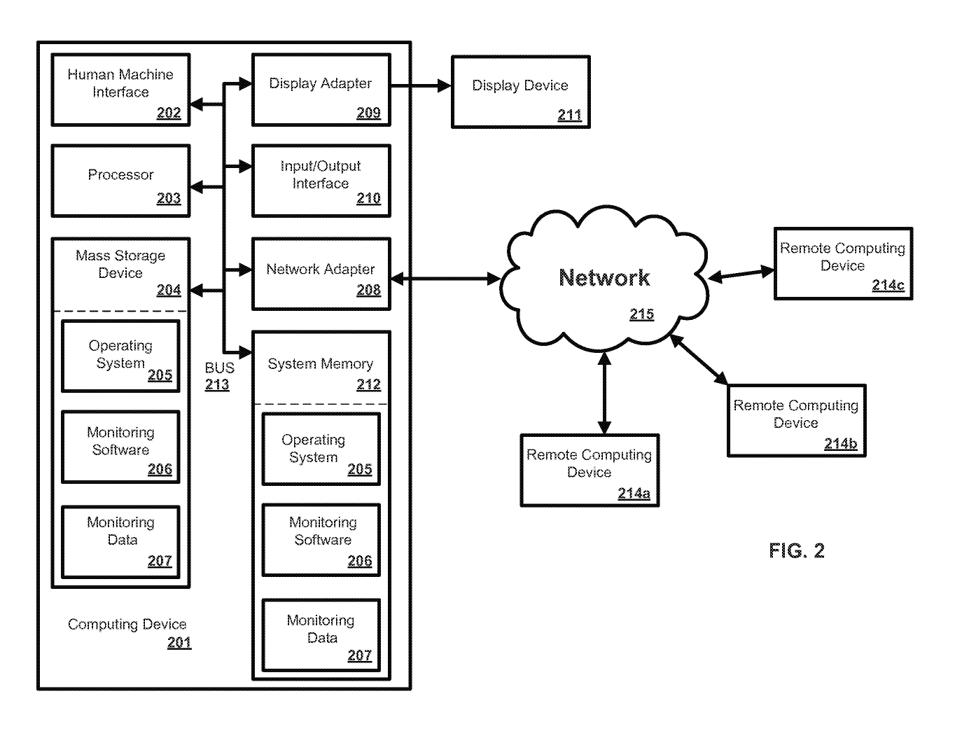

In an exemplary aspect, the methods and systems can be implemented on a computing system such as computing device 201 as illustrated in FIG. 2 and described below. By way of example, one or more of the user device 102 and the computing device 104 of FIGS. 1A-1B can be a computer as illustrated in FIG. 2. Similarly, the methods and systems disclosed can utilize one or more computers to perform one or more functions in one or more locations. FIG. 2 is a block diagram illustrating an exemplary operating environment for performing the disclosed methods. This exemplary operating environment is only an example of an operating environment and is not intended to suggest any limitation as to the scope of use or functionality of operating environment architecture. Neither should the operating environment be interpreted as having any dependency or requirement relating to any one or combination of components illustrated in the exemplary operating environment.

The present methods and systems can be operational with numerous other general purpose or special purpose computing system environments or configurations. Examples of well known computing systems, environments, and/or configurations that can be suitable for use with the systems and methods comprise, but are not limited to, personal computers, server computers, laptop devices, and multiprocessor systems. Additional examples comprise set top boxes, programmable consumer electronics, network PCs, minicomputers, mainframe computers, distributed computing environments that comprise any of the above systems or devices, and the like.

The processing of the disclosed methods and systems can be performed by software components. The disclosed systems and methods can be described in the general context of computer-executable instructions, such as program modules, being executed by one or more computers or other devices. Generally, program modules comprise computer code, routines, programs, objects, components, data structures, etc. that perform particular tasks or implement particular abstract data types. The disclosed methods can also be practiced in grid-based and distributed computing environments where tasks are performed by remote processing devices that are linked through a communications network. In a distributed computing environment, program modules can be located in both local and remote computer storage media including memory storage devices.

Further, one skilled in the art will appreciate that the systems and methods disclosed herein can be implemented via a general-purpose computing device in the form of a computing device 201. The components of the computing device 201 can comprise, but are not limited to, one or more processors or processing units 203, a system memory 212, and a system bus 213 that couples various system components including the processor 203 to the system memory 212. In the case of multiple processing units 203, the system can utilize parallel computing.

The system bus 213 represents one or more of several possible types of bus structures, including a memory bus or memory controller, a peripheral bus, an accelerated graphics port, and a processor or local bus using any of a variety of bus architectures. By way of example, such architectures can comprise an Industry Standard Architecture (ISA) bus, a Micro Channel Architecture (MCA) bus, an Enhanced ISA (EISA) bus, a Video Electronics Standards Association (VESA) local bus, an Accelerated Graphics Port (AGP) bus, and a Peripheral Component Interconnects (PCI), a PCI-Express bus, a Personal Computer Memory Card Industry Association (PCMCIA), Universal Serial Bus (USB) and the like. The bus 213, and all buses specified in this description can also be implemented over a wired or wireless network connection and each of the subsystems, including the processor 203, a mass storage device 204, an operating system 205, monitoring software 206, monitoring data 207, a network adapter 208, system memory 212, an Input/Output Interface 210, a display adapter 209, a display device 211, and a human machine interface 202, can be contained within one or more remote computing devices 214a,b,c at physically separate locations, connected through buses of this form, in effect implementing a fully distributed system,

The computing device 201 typically comprises a variety of computer readable media. Exemplary readable media can be any available media that is accessible by the computing device 201 and comprises, for example and not meant to be limiting, both volatile and non-volatile media, removable and non-removable media. The system memory 212 comprises computer readable media in the form of volatile memory, such as random access memory (RAM), and/or non-volatile memory, such as read only memory (ROM). The system memory 212 typically contains data such as monitoring data 207 and/or program modules such as operating system 205 and monitoring software 206 that are immediately accessible to and/or are presently operated on by the processing unit 203.

In another aspect, the computing device 201 can also comprise other removable/non-removable, volatile/non-volatile computer storage media. By way of example, FIG. 2 illustrates a mass storage device 204 which can provide non-volatile storage of computer code, computer readable instructions, data structures, program modules, and other data for the computing device 201. For example and not meant to be limiting, a mass storage device 204 can be a hard disk, a removable magnetic disk, a removable optical disk, magnetic cassettes or other magnetic storage devices, flash memory cards, CD-ROM, digital versatile disks (DVD) or other optical storage, random access memories (RAM), read only memories (ROM), electrically erasable programmable read-only memory (EEPROM), and the like.

Optionally, any number of program modules can be stored on the mass storage device 204, including by way of example, an operating system 205 and monitoring software 206. Each of the operating system 205 and monitoring software 206 (or some combination thereof) can comprise elements of the programming and the monitoring software 206. Monitoring data 207 can also be stored on the mass storage device 204. Monitoring data 207 can be stored in any of one or more databases known in the art. Examples of such databases comprise, DB2®, Microsoft® Access, Microsoft® SQL Server, Oracle®, mySQL, PostgreSQL, and the like. The databases can be centralized or distributed across multiple systems.

In another aspect, the user can enter commands and information into the computing device 201 via an input device (not shown). Examples of such input devices comprise, but are not limited to, a keyboard, pointing device (e.g., a “mouse”), a microphone, a joystick, a scanner, tactile input devices such as gloves, and other body coverings, and the like These and other input devices can be connected to the processing unit 203 via a human machine interface 202 that is coupled to the system bus 213, but can be connected by other interface and bus structures, such as a parallel port, game port, an IEEE 1394 Port (also known as a Firewire port), a serial port, or a universal serial bus (USB).

In yet another aspect, a display device 211 can also be connected to the system bus 213 via an interface, such as a display adapter 209. It is contemplated that the computing device 201 can have more than one display adapter 209 and the computer 201 can have more than one display device 211. For example, a display device can be a monitor, an LCD (Liquid Crystal Display), or a projector. In addition to the display device 211, other output peripheral devices can comprise components such as speakers (not shown) and a printer (not shown) which can be connected to the computing device 201 via Input/Output Interface 210. Any step and/or result of the methods can be output in any form to an output device. Such output can be any form of visual representation, including, but not limited to, textual, graphical, animation, audio, tactile, and the like. The display 211 and computing device 201 can be part of one device, or separate devices.

The computing device 201 can operate in a networked environment using logical connections to one or more remote computing devices 214a,b,c. By way of example, a remote computing device can be a personal computer, portable computer, a smart phone, a server, a router, a network computer, a peer device or other common network node, and so on. Logical connections between the computing device 201 and a remote computing device 214a,b,c can be made via a network 215, such as a local area network (LAN) and a general wide area network (WAN). Such network connections can be through a network adapter 208. A network adapter 208 can be implemented in both wired and wireless environments. Such networking environments are conventional and commonplace in dwellings, offices, enterprise-wide computer networks, intranets, and the Internet.

For purposes of illustration, application programs and other executable program components such as the operating system 205 are illustrated herein as discrete blocks, although it is recognized that such programs and components reside at various times in different storage components of the computing device 201, and are executed by the data processor(s) of the computer. An implementation of monitoring software 206 can be stored on or transmitted across some form of computer readable media. Any of the disclosed methods can be performed by computer readable instructions embodied on computer readable media. Computer readable media can be any available media that can be accessed by a computer. By way of example and not meant to be limiting, computer readable media can comprise “computer storage media” and “communications media.” “Computer storage media” comprise volatile and non-volatile, removable and non-removable media implemented in any methods or technology for storage of information such as computer readable instructions, data structures, program modules, or other data. Exemplary computer storage media comprises, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by a computer.

The methods and systems can employ Artificial Intelligence techniques such as machine learning and iterative learning. Examples of such techniques include, but are not limited to, expert systems, case based reasoning, Bayesian networks, behavior based AI, neural networks, fuzzy systems, evolutionary computation (e.g. genetic algorithms), swarm intelligence (e.g. ant algorithms), and hybrid intelligent systems (e.g. Expert inference rules generated through a neural network or production rules from statistical learning).

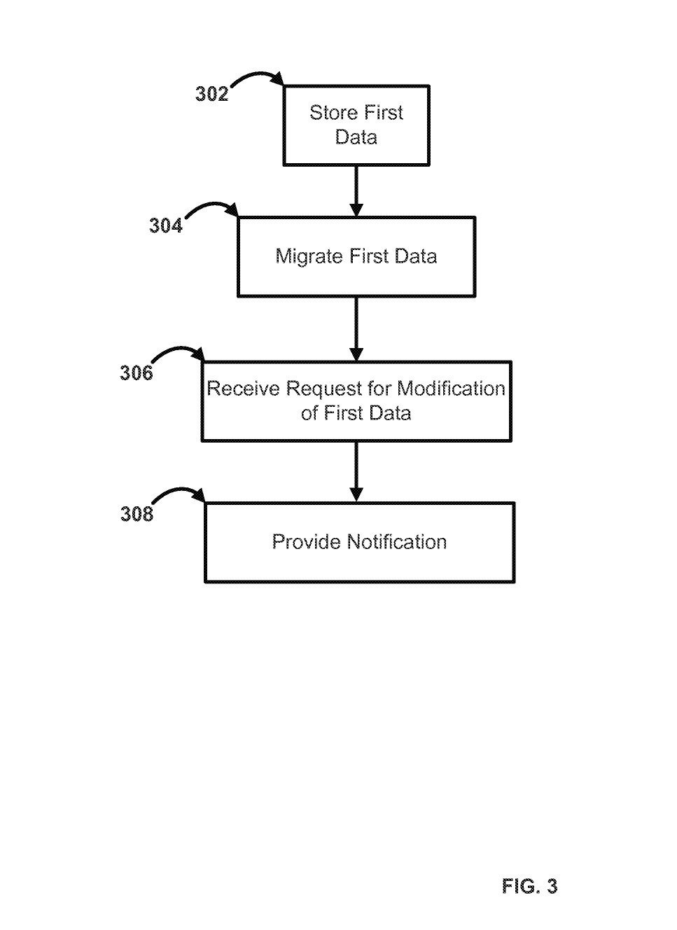

In an aspect, illustrated in FIG. 3, provided are methods for managing data. In step 302, first data can be stored in a first database. In an aspect, the first data can comprise content such as one or more video assets, audio assets, images, text, etc. In another aspect, the first database can comprise one or more partitions of a storage medium. As an example, the first database can be associated with a particular user. As a further example, the first data may be secured such that an authentication procedure may be required to access the first data.

In step 304, the first data can be migrated (e.g., replicated, copied, moved, divided, etc.) from the first database to a second database. In an aspect, the second data can comprise content such as one or more video assets, audio assets, images, text, and the like. In an aspect, migrating the first data can comprise storing second data in the second database. The second data can be a copy of the first data. Storing the second data can comprise moving the first data to the second database, whereby the moved first data becomes the second data. As an example, migrating the first data can be executed in response to a database event, such as a load balancing, database changes such as schema, re-indexing, or reaching a threshold or capacity. As another example, migrating can be scheduled. Migrating data can be used to balance load across partitions. If a single partition contains too much data or handles too much traffic, migration of specific user data to another partition can facilitate a balance of partition loads. As a further example, load balancing can be facilitated by migrating the first data between multiple locations. In another aspect, the first data can be migrated from a first partition of a storage medium to a second partition of the medium. In yet another aspect, data migration can comprise transferring (e.g., replicating, copying, moving, dividing, etc.) data between storage types, formats, or computer systems. As an example, data migration can be performed programmatically to achieve an automated migration. As another example, the second database can be associated with a particular user. As a further example, the second data may be secured such that an authentication procedure may be required to access the second data.

In step 306, a request for modification of the first data in the first database can be received. In an aspect, the request may be received during migration of the first data. As an example, the request can be addressed to first database. As a further example, the request can be transmitted from a user (e.g., authenticated) user for manipulating the first data. In another aspect, first data can be modified (e.g., automatically) based upon the received request. In another aspect, step 304 and step 306 are not required and can be skipped in the process.

In step 308, a notification can be provided based on the request for modification. In an aspect, notifications can be or comprise HTTP response bodies, such as:

```
{
    “$xmlns”: {
      “plcategory”: “xml.example.com/Category”
    },
    “id”: 41443634,
    “method”: “post”,
    “type”: “Category”,
    “entry”: {
      “id”: “example.com/data/1234”,
      “updated”: 1360267140000,
      “ownerId”:“example.com/data/Account/2429506505”,
      “updatedByUserId”:
“identity.auth.test.corp.example.com/idm/data/User/mps/249914844”,
      “plcategory$fullTitle”: “msn”,
      “Plcategory$scheme”: “catalog.example.com”
      }
```

As an example, a notification can comprise an identifier, such as a numeric identifier, for the notification. The identifier can allow users to stop or pause processing and resume at a later time without losing data. As another example, a notification can comprise one or more operations performed (e.g., create, delete, or update). As another example, a notification can comprise a type of object that was modified (e.g., media or category). As a further example, a notification can comprise one or more attributes of the object, such as a unique identifier of the object, a title, and a time and/or date the object was modified. Other information can be included as part of the notification. Notifications can take other forms.

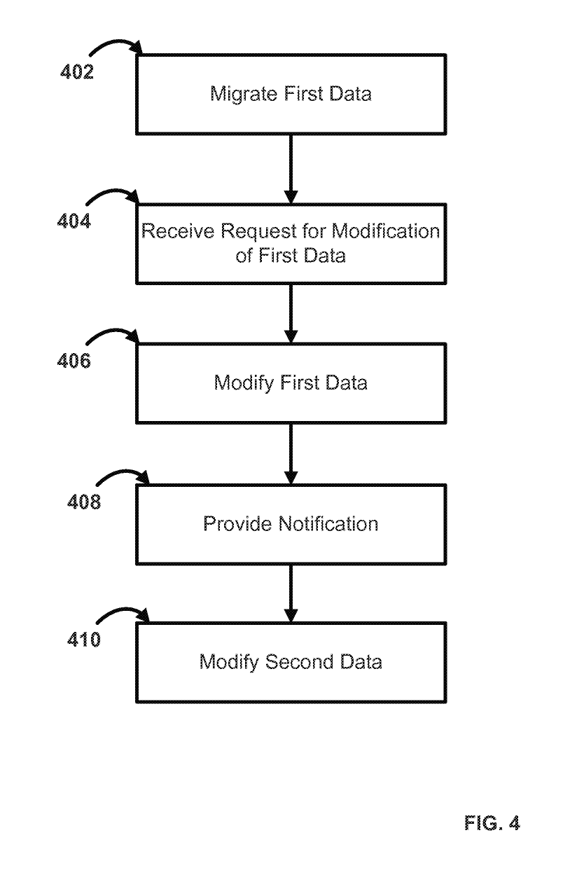

FIG. 4 illustrates an exemplary method for managing data. In step 402, first data can be migrated (e.g., replicated, copied, moved, divided, etc.) from the first database to a second database. In an aspect, migrating the first data can comprise storing second data. In the second database. The second data can be a copy of the first data. Storing the second data can comprise moving the first data to the second database, whereby the moved first data becomes the second data. In an aspect, the second data can comprise content such as one or more video assets, audio assets, images, text, and the like. As an example, migrating the first data can be executed in response to a database event, such as a load balancing, database changes such as schema, re-indexing, or reaching a threshold or capacity. As another example, migrating can be scheduled. Migrating data can be used to balance load across partitions. If a single partition contains too much data or handles too much traffic, migration of specific user data to another partition can facilitate a balance of partition loads. As a further example, load balancing can be facilitated by migrating the first data between multiple locations. In another aspect, the first data can be migrated from a first partition of a storage medium to a second partition of the medium. In yet another aspect, data migration can comprise transferring (e.g., replicating, copying, moving, dividing, etc.) data between storage types, formats, or computer systems. As an example, data migration can be performed programmatically to achieve an automated migration. As another example, the second database can be associated with a particular user. As a further example, the second data may be secured such that an authentication procedure may be required to access the second data.

In step 404, a request for modification can be received. As an example, the request can relate to the first data. As a further example, the request can relate to database changes such as schema, re-indexing, or reaching a threshold or capacity. In an aspect, the request may be received during migration of the first data. As an example, the request can be addressed to first database. As a further example, the request can be transmitted from a user (e.g., authenticated) user for manipulating the first data. In another aspect, the first data can be modified (e.g., automatically) based upon the received request, at step 406.

In step 408, a notification can be provided (e.g., transmitted, generated, etc.) based on the request for modification. In an aspect, notifications can be or comprise HTTP response bodies. As an example, a notification can comprise an identifier, such as a numeric identifier, for the notification. The identifier can allow users to stop or pause processing and resume at a later time without losing data. As another example, a notification can comprise one or more operations performed (e.g., create, delete, or update). As another example, a notification can comprise a type of object that was modified (e.g., media or category). As a further example, a notification can comprise one or more attributes of the object, such as a unique identifier of the object, a title, and a time and/or date the object was modified. Other information can be included as part of the notification. Notifications can also be sent to the a user to indicate a location of migrated content.

In step 410, the second data can be modified based upon the notification. As an example, the second data can be modified to match at least a portion of the modified first data. In an aspect, a device such as the computing device 104 and/or data management device 120 can receive the notification and can modify the second data based on the notification. As such, the complete first data is not required to be completely migrated each time the first data is modified. Instead, as the first data changes, a notification can be provided to facilitate the updating of the second data.

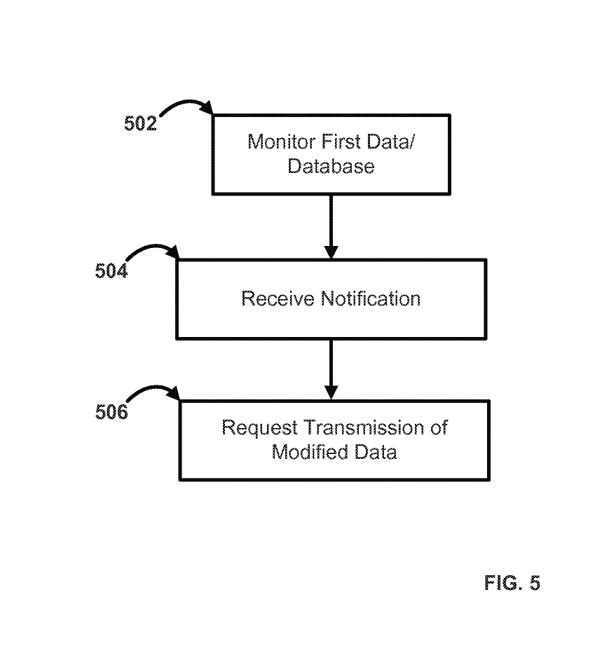

FIG. 5 illustrates an exemplary method for managing data. In step 502, a first database can be monitored (e.g., tracked, queried, pinged, etc.). In an aspect, the first database can comprise one or more partitions of a storage medium. As an example, the first database can be associated with a particular user. As a further example, the first data may be secured such that an authentication procedure may be required to access the first data.

In step 504, a notification can be received. In an aspect, the notification can relate to a modification of data stored in the first database. In an aspect, notifications can be or comprise HTTP response bodies. As an example, a notification can comprise an identifier, such as a numeric identifier, for the notification. The identifier can allow users to stop or pause processing and resume at a later time without losing data. As another example, a notification can comprise one or more operations performed (e.g., create, delete, or update). As another example, a notification can comprise a type of object that was modified (e.g., media or category). As a further example, a notification can comprise one or more attributes of the object, such as a unique identifier of the object, a title, and a time and/or date the object was modified. Other information can be included as part of the notification. Notifications can take other forms.

In step 506, transmission of modified data to a second database can be requested. In an aspect, the transmission request can be automated. In a further aspect, the transmission request can be based on the notification. As an example, a recipient of the notification can determine if the second database should be updated based upon the notification. As such, the recipient of the notification can request that the modified data be transmitted to the second database.

While the methods and systems have been described in connection with preferred embodiments and specific examples, it is not intended that the scope be limited to the particular embodiments set forth, as the embodiments herein are intended in all respects to be illustrative rather than restrictive.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that an order be inferred, in any respect. This holds for any possible non-express basis for interpretation, including: matters of logic with respect to arrangement of steps or operational flow; plain meaning derived from grammatical organization or punctuation; the number or type of embodiments described in the specification.

It will be apparent to those skilled in the art that various modifications and variations can be made without departing from the scope or spirit. Other embodiments will be apparent to those skilled in the art from consideration of, the specification and practice disclosed herein. It is intended that the specification and examples be considered as exemplary only, with a true scope and spirit being indicated by the following claims.

What is claimed is:

1. A method comprising:
storing first data in a first database;
migrating the first data from the first database to a second database by storing the first data as second data in the second database;
receiving a request for modification of the first data in the first database during migration of the first data; and
providing a notification based on the request for modification.

2. The method of claim 1, wherein the second data comprises a copy of the first data.

3. The method of claim 1, wherein migrating the first data comprises moving the first data to the second database, wherein the moved first data becomes the second data.

4. The method of claim 1, wherein the first database and the second database are partitions of a storage medium.

5. The method of claim 1, wherein the first database and the second database are associated with a particular user.

6. The method of claim 1, further comprising modifying the first data based upon the request for modification.

7. The method of claim 1, further comprising modifying data stored in the second database based on the notification.

8. The method of claim 1, wherein the request or modification is addressed to first database.

9. A method comprising:
migrating first data from a first database to a second database by storing the first data as second data in the second database;
modifying at least a portion of the first data during migration of the first data;
providing a notification to the second database based on the modification of the first data; and
modifying the second data based upon the notification, wherein the second data is modified to match at least a portion of the modified first data.

10. The method of claim 9, wherein the second data comprises a copy of the first data.

11. The method of claim 9, wherein migrating the first data comprises moving the first data to the second database, wherein the moved first data becomes the second data.

12. The method of claim 9, wherein the first database and the second database are partitions of a storage medium.

13. The method of claim 9, wherein the first database and the second database are associated with a particular user.

14. The method of claim 9, wherein migrating the first data is executed in response to a database event.

15. A method comprising:
monitoring a first database;
receiving a notification relating to a modification of data stored in the first database; and
automatically requesting transmission of modified data to a second database based on the notification.

16. The method of claim 15, wherein the data in the first database comprises one or more content assets.

17. The method of claim 15, wherein the first database and the second database are partitions of a storage medium.

18. The method of claim 15, wherein the first database and the second database are associated with a particular user.

19. The method of claim 15, wherein the notification comprises an HTTP response body.

20. The method of claim 15, wherein monitoring a first database comprises monitoring the first database while data is being migrated from the first database to the second database.
